(19) United States
(12) Patent Application Publication
(10) Pub. No.: US 2009/0154626 A1
(43) Pub. Date: Jun. 18, 2009

(54) CONTINUOUS RECEIVER CLOCK ALIGNMENT AND EQUALIZATION OPTIMIZATION

(76) Inventors: Warren R. Anderson, Westborough, MA (US); Matthew E. Becker, Harvard, MA (US)

Correspondence Address: Caroline F. Fleming;Intel Corporation, c/o Intellevate, LLC, P.O. Box 52050, Minneapolis, MN, 55402, US

(21) Appl. No.: 11/957,451

(22) Filed: Dec. 15, 2007

(51) Int. Cl. H04L 7/02

(52) U.S. Cl. 375/360

(57) ABSTRACT

The available bandwidth of an Input/Output (I/O) communications link is increased by removing the need for retraining events on a communications link. This results in removing a potentially severe system performance degradation penalty that may occur from data traffic stoppage during the retraining events. The available bandwidth is further increased by removing a timing error which results in increasing a timing margin for other components. This results in an increase in the maximum speed of systems with high speed I/O and communication transceiver Integrated Circuits (IC)s.

### FIELD

This disclosure relates to high speed Input/Output (IO) links and in particular to high-speed IO link receivers.

### BACKGROUND

High-speed Input Output (IO) link receivers that interface to high speed IO links such as Peripheral Component Interconnect (PCI) Express, Dual Data Rate (DDR) and Quick Path Interconnect (QPI) need to align a sampling clock to received data in order to correctly sample the received data. In order to compensate for drift of the sampling clocks that may be caused by thermally-induced delay changes in the clock distribution network and other sources, periodic retraining of the sampling clock's alignment is performed. Typically, the re-training is performed by halting the data traffic on a communications link to the I/O link receiver to allow the receiver to align the sampling clock to a known data pattern. This operation may be referred to as a “retraining event.”

A disadvantage of the retraining event is that the halted data traffic on the communications link may back up in upstream communication links. This may result in a distinct performance impact in a communication network, for example, in a mesh-based network, that is, a network in which nodes may connect to each other via multiple hops. Also, the additional support required for performing and coordinating the training event adds complexity to the high speed IO communications link and may also increase power consumption.

High-speed IO links may also incorporate receiver equalization to compensate for transmission line loss by providing a frequency dependent gain. The high-speed IO links may also need to compensate for amplifier offset. These receiver circuits are also sensitive to process, voltage, and temperature. The equalizer settings controlling the frequency dependent gain parameters may be programmable to allow for optimization, which may be performed once at initialization or may be performed dynamically. Similar to retraining of the sampling clock, receiver equalization (or offset) re-training also often requires halting normal data traffic, which is generally not desired.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 illustrates an eye diagram for receive data and the relationship of sampling clocks to the receive data;

FIGS. 2A-B are timing diagrams that illustrate a method for continuously following the phase of input data;

FIG. 3 is a block diagram of an embodiment of a high speed Input/Output (IO) link receiver that includes a redundant interpolator/sampler pair according to the principles of the present invention;

FIG. 4 is a timing diagram that illustrates clock positions and register settings found by the redundant interpolator/sampler shown in FIG. 3 while tuning during normal operation.

FIG. 5 is a flow graph of an embodiment of a method for performing continuous optimization of clock alignment and equalization coefficients;

FIG. 6 is a block diagram of a system that includes an embodiment of a receiver that performs continuous retraining; and

FIG. 7 is a block diagram of an embodiment of a receiver that includes N interpolator/sampler pairs.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

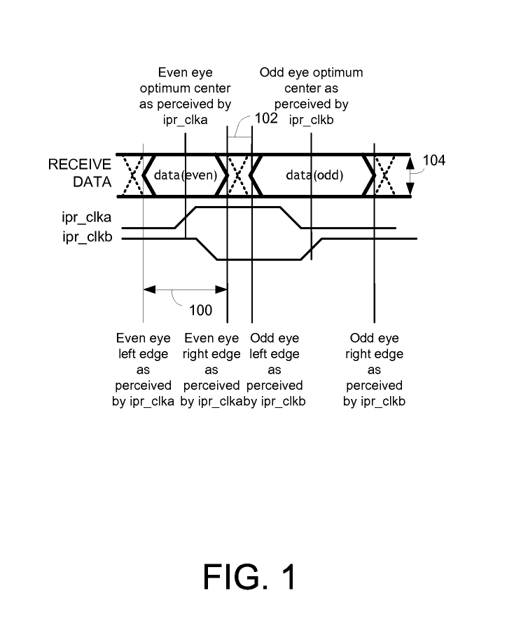

An eye diagram is a means to display a digital signal by overlaying the signal relative to a repetitive sampling point. FIG. 1 illustrates a typical eye diagram for receive data and the relationship of sampling clocks to the receive data. The eye diagram is typically used to evaluate the quality of the digital signal. The eye width 100 is a measure of timing margin relative to synchronization errors and jitter effects. The width of the crossover 102 represents the amount of jitter in the received signal and the slope of the eye represents sensitivity to timing errors. The eye height 104 represents the voltage level of the received signal relative to voltage noise sources such as thermal noise and power supply variation.

Deviations of sampling clocks (ipr_clka and ipr_clkb) from the ideal location shown in FIG. 1, result in timing errors and loss of margin, that is, when the measured signal to noise ratio is below the required signal to noise ratio, resulting in increased link bit error rates.

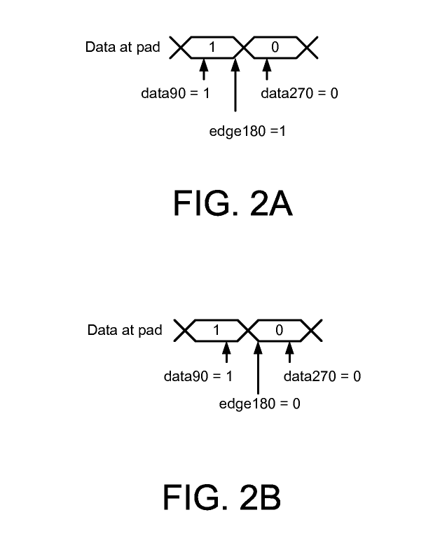

FIGS. 2A-2B illustrate a method for continuously following the phase of receive data. FIG. 2A illustrates an example in which sampling clocks are early with respect to data transition edges. FIG. 2B illustrates an example in which the sampling clocks are late with respect to data transition edges.

A pseudo-Clock Data Recovery (CDR) tracking loop may be used to maintain a clock that is positioned at data transition edges. This is illustrated in FIGS. 2A-2B, where data 90 and data 270 indicate the position of the data sampling clocks and edge 180 represents the position of the sampling clock that is continuously aligned to the data transition edge. The sampling clocks all move together, with the accumulated early and late information derived from the edge 180 sampling clock indicating how the clocks should move. The pseudo-CDR method relies on matching between interpolators. In advanced silicon processes, mismatch between nominally identical devices such as interpolators becomes so significant that there may be significant timing errors between nominally identical interpolators. In addition, the continuous-tracking pseudo-CDR mechanism contains a loop latency and therefore an effective bandwidth. Depending on the frequency of the jitter that the pseudo-CDR tries to track, the pseudo-CDR latency may cause the tracking to become 180 degrees out of phase with the input jitter and the pseudo-CDR may amplify the input jitter.

For equalization optimization, other techniques such as adaptive equalization are sometimes used. However, these techniques require complex error detection and adjustment circuits and cannot sense either the vertical or horizontal edges of the data eye, as may be desired in order to optimize the equalization to maximize either of these two parameters, because this necessarily corrupts the data at the receiver output.

In an embodiment of the present invention, each interpolator determines its own optimal placement, so no matching is required. Each interpolator finds its optimum sampling point around the actual data eye that it senses. Jitter is not amplified because the interpolator settings are static while in data capture mode. Optimization of the equalization/offset parameters is provided by maximizing the eye height and/or eye width as perceived at the actual sampler output.

An embodiment of the present invention provides a means to continuously adjust a position of a sampling clock to a perceived center of an eye of the received signal, provides a means to continuously adjust settings of a receiver equalizer or offset to maximize the height and the width of the eye of the received signal on the eye diagram, as perceived by the receiver itself and does not halt or corrupt the received data stream.

In one embodiment continuous optimization of clock alignment and equalization/offset coefficients is performed without a re-training event. The continuous optimization is performed through continually adjusting the clock alignment position and receiver equalization/offset settings using the input data stream and measuring the eye width or height.

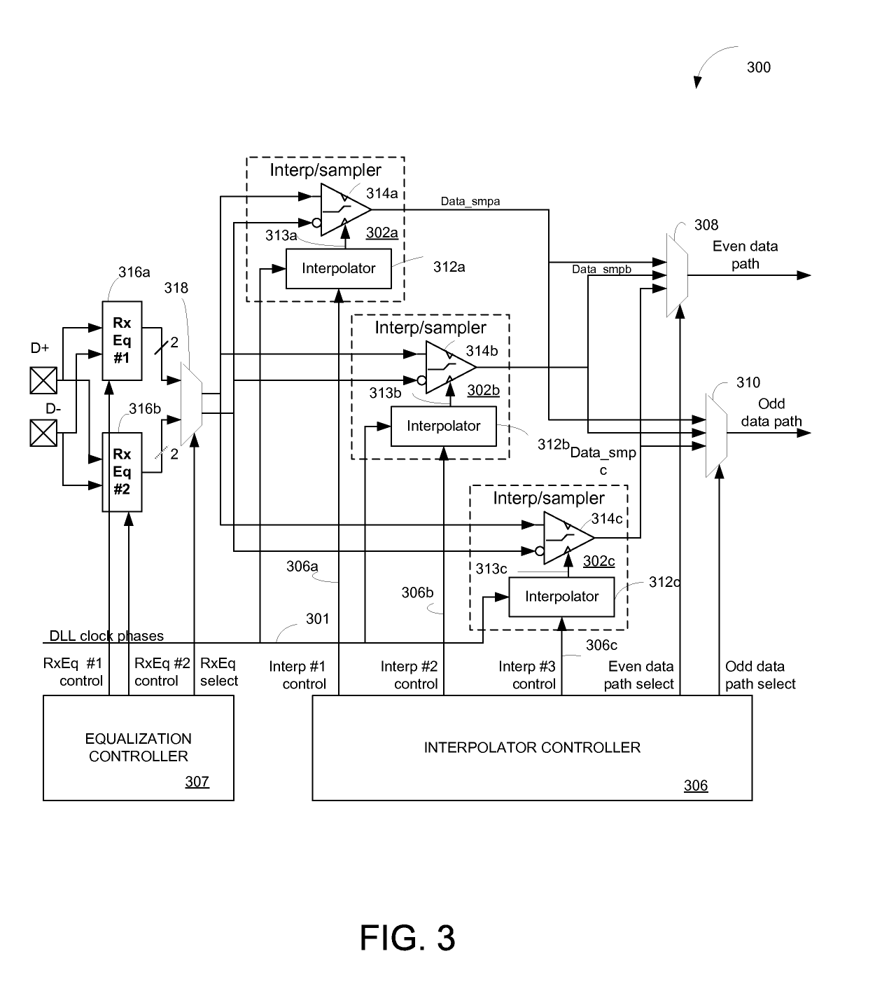

FIG. 3 is a block diagram of a portion of an embodiment of a high speed Input/Output (IO) link receiver 300 that includes a redundant interpolator/sampler according to the principles of the present invention.

Receiver 300 receives a differential data signal (D+, D−) and associated Delay Lock Loop (DLL) clock phases (sampling clocks) 301. In an embodiment for Double Data Rate (DDR), receiver 300 receives two data symbols per clock cycle and, accordingly, there are two data transitions per clock cycle, one on the rising edge of the clock (even data path) and the other on the falling edge of the clock (odd data path).

In the embodiment shown there are three interpolator/samplers 302a, 302b, 302c. At any one time, two of the three interpolators/samplers 302a, 302b, 302c are actively tracking data edges, for example, one for an even data path 302a and the other for an odd data path 302b and the third interpolator/sampler (the redundant interpolator/sampler) 302c is tracking the edge or measuring the eye size (width/height).

A delay lock loop (DLL) generates multiple DLL clock phases 301 having a known and fixed relationship to one another based on a received clock signal. Each respective interpolator 312a, 312b, 312c in each interpolator/sampler pair 302a, 302b, 302c receives the multiple DLL clock phases 301 and based on control signals 306a, 306b, 306c outputs a selected one of the DLL clock phases to track the respective data edge.

The interpolator controller 306 also selects which of the interpolator/sampler pairs 302a, 302b, 302c provides the data signal for the even data path 304a through multiplexer 308 and provides the data signal for the odd data path 304b through multiplexer 310.

Samplers 314a, 314b, 314c receive a respective clock signal 313a, 313b, 313c from the respective interpolator 312a, 312b, 312c and a data signal from a transmitter forwarded through receive equalizers 316a, 316b and multiplexer 318. Each of the samplers 314a, 314b, 314c acquires a first sample based on the respective clock signal 313a, 313b, 313c.

The adjustment of the clock alignment position is made through a continuous scan of the receiver eye by a redundant interpolator and sampler pair. In one embodiment, there are three interpolator and sampler pairs 302a, 302b, 302c, one each for odd and even data sampling and a third to scan the receiver eye diagram corresponding to the input signal for the optimum clock position. In the embodiment shown, there are two equalizers 316a, 316b. With one of the equalizers being the active equalizer and the other being the redundant equalizer. The redundant equalizer may be distinct as shown in FIG. 3 or may be built into each sampler 314a, 314b, 314c. The interpolator/sampler pairs and the equalizer may be interchanged so that, when the redundant interpolator/sampler and equalizer pair has found the optimum position, the pair can be switched in as the actual data sampler. The interpolator/sampler and equalizer pair that was swapped out becomes redundant and may begin to look for the optimum position.

As indicated above, in the embodiment shown in FIG. 3, the continuous optimization uses three independent sampler and interpolator pairs 302a, 302b, 302c, with independent control signals from interpolator controller 306, and at least one equalizer 316a, 316b. In an embodiment with a single equalizer/offset, the equalizer has thermally encoded or gray encoded controls with a fine granularity so as to not cause errors in the operational sampler. In another embodiment equalizer 316b in combination with the redundant interpolator/sampler may be tuned in parallel during normal operation. This eliminates the need for thermal coding or fine granularity. After the equalizer has been trained, the equalizer may be swapped into the data path. Amplifier voltage offset correction may be included in the samplers 314a, 314b, 314c or as part of the front-end stage (equalizer in this embodiment in addition to sampling time offset correction

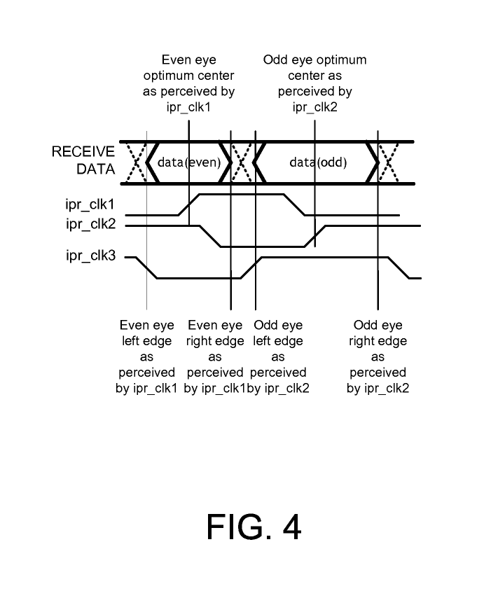

FIG. 4 is a timing diagram that illustrates clock positions and register settings found by the redundant interpolator/sampler shown in FIG. 3 while tuning during normal operation.

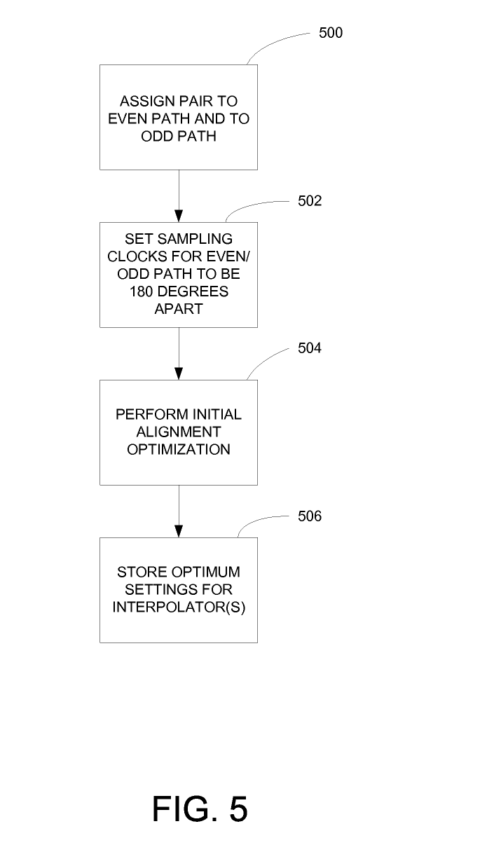

In an embodiment with more than one equalizer, each of the equalizers has independent settings controlled by an equalization controller 307. The continuous optimization of clock alignment and equalization coefficients will be described in conjunction with the flow graph shown in FIG. 5.

At block 500, during initialization, one of the three interpolator/sampler pairs 302a, 302b, 302c is assigned to be the default unit for the even data path and another one of the three interpolator/sampler pairs 302a, 302b, 302c is assigned to be the default unit for the odd data path. Processing continues with block 502.

At block 502, the initial control settings in the interpolator controller 306 are configured such that the two output clocks from the two interpolators 312a, 312b, 312c in the two default interpolator/sampler pairs 302a, 302b, 303c assigned to be the default units are 180 degrees apart. Processing continues with block 504.

At block 504, having the output clocks 180 degrees apart is often not the optimum position, because of duty cycle distortion. Thus, initial alignment optimization may be performed using an eye sweep algorithm. The interpolator in the primary interpolator/sampler pairs is scanned away from its initial position by adjusting the DLL clock phase (sampling clock) 301 received by the interpolator.

The boundaries of the data eye can be determined by sweeping the redundant sampler in the redundant sampler interpolator pair relative to the data sampler for the even or odd path. When the value of the sampler in the redundant sampler interpolator pair value regularly differs from its associated even/odd data sampler, the sampler has entered the eye edge region. The data pattern used for training may be unknown, may include a pattern of alternating 0 and is “0101” traffic, a Pseudo Random Bit Sequence (PRBS) data pattern or random data.

For example, the interpolator in the interpolator/sampler pair assigned to the even data path may be swept to the left by appropriate selection of the DLL clock phase until the output data from the sampler in the interpolator/sampler pair transitions from a matching logical value to an unmatched logical value. Then, the interpolator is swept to the right edge of the data eye and the selected sample clock recorded when the output data transitions from a matched to unmatched value. The optimum point is the center of the data eye, that is, the point that is in the center of the detected left and right eye transition positions. In an embodiment, the sweep may be performed independently on each interpolator, that is, first on the interpolator in the interpolator/sampler pair assigned to the even data path and then on the interpolator in the interpolator/sampler pair assigned to the odd data path. In another embodiment, the sweep may be performed simultaneously in the interpolators assigned to the even data path and the odd data path.

In another embodiment the redundant sampler is fixed relative to the even (or odd) sampler 314a, 314b, 314c with a modest phase difference. Both samplers are swept together across the data eye. When the values reported by the two samplers differ, the interpolator controller 306 knows that the position is not in the open portion of the data eye. When the samplers begin to return the same value, the interpolator controller 306 may mark the position as one edge of the data eye. The interpolator controller 306 may continue the sweep across the data eye until the values returned by the samplers 314a, 314b, 314c differ again, this position represents the other boundary of the data eye. The initial position of the even (or odd) sampler can be set at the numerical average of the two boundaries. Processing continues with block 506.

At block 506, the interpolator controller 306 includes a register indicating where each interpolator/sampler pair 302a, 302b, 302c found the left and right edges of its respective data eye. During initialization, the positions at which the eye edges are found are recorded in this register. The optimum setting for each interpolator 312a, 312b, 312c is the midpoint between the left and right edges and is recorded in another register in the interpolator controller 306.

The third sampler/interpolator may be used as a means to obtain the expected data by positioning it near the middle of the data eye while the sweep takes place or it may be ignored. Initialization is complete.

After the initialization is complete and normal data traffic begins, the interpolators assigned to both the odd and even data paths are continuously adjusted to maintain the sampling clock at the optimum sampling point. The adjustment is performed without requiring any retraining event and the input data is propagated without interruption.

To maintain the flow of data traffic, the interpolator/sampler combinations that have been trained and tuned, sample the input data at their selected sampling clock phase. For example, initially, the output of sampler 314a may be selected for the even data path and the output of sampler 314b may be selected for the odd data path through the data path multiplexers via even data path/odd data path select control signals from the interpolator controller 306. Thus, in this embodiment for DDR, interpolator/sampler pairs 302a, 302b are the primary interpolator/sampler pairs and interpolator/sampler pair 302c is the secondary (redundant) interpolator/sampler pair.

During this time, interpolator/sampler 302c may begin an eye sweep tuning operation on the data eye for the even data path. As shown in FIG. 4, interpolator/sampler 302c tunes to the data eye in the even data path by first finding the left edge of the data eye for the even data path and then finding the right edge of the data eye for the even data path. Due to device mismatch and voltage and temperature drift, the positions at which interpolator/sampler 302c finds the left and right edge of the data eye for the even data path may differ from the positions found for interpolator/sampler 302a. The values for the right edge and the left edge of the data eye for the even data path are stored in the control registers for interpolator/sampler 302c in interpolator controller 306. The optimum data eye center for the even data path as perceived by interpolator/sampler 302c, may then be determined as the midpoint between the right edge position (value) and the left edge position (value).

The output of sampler 302a represents the correct data for the data eye for the even data path. The output of sampler 302b may be used to determine if a data transition occurred. The inside/outside calculation may be qualified only when a transition occurs because the data eye occurs only when there is a transition at one or the other edge. Thus, the interpolator controller 306 may determine if the sampling clock for interpolator/sampler 302c is inside or outside of the data eye by performing the calculation shown below in Table 1.

The respective output signals from samplers 314a, 314b, and 314c are labeled data_smpa, data_smpb, and data_smpc. The inside_left and inside_right signals indicate that the clock input to the respective sampler 314a, 314b, 314c is positioned inside of the data eye. Likewise, outside_left and outside_right signals indicate that the respective clock input to samplers 314a, 314b, 314c is positioned outside of the data eye. The search_left and search_right signals indicate that the search is for the left or for the right edge of the data eye, respectively. Clocks clka, clkb, and clkc are the outputs of the respective interpolators 312a, 312b, 312c, that are coupled to the respective samplers 314a, 314b, 314c. It is assumed that the sampler data output is valid for a full cycle in the respective clock domain and that the logic operates with zero delay.

```
TABLE 1
assign inside_left_calc = search_left &(data_smpa \hat{ } data_smpb)
                                & ~(data_smpc \hat{ } data_smpa);
always @(posedge clkb)  // Flop before data_smpa changes
    inside_left <= inside_left_calc;
assign outside_left_calc = search_left &(data_smpa \hat{ } data_smpb)
                                & (data_smpc \hat{ } data_smpa);
always @(posedge clkb)  // Flop before data_smpb changes
    outside_left <= outside_left_calc;
assign inside_right_calc = search_right &(data_smpa \hat{ } data_smpb)
                                & ~(data_smpc \hat{ } data_smpa);
always @(posedge clka)  // Flop before data_smpa changes
    inside_right <= inside_right_calc;
assign outside_right_calc = search_right &(data_smpa \hat{ } data_smpb)
                                & (data_smpc \hat{ } data_smpa);
always @(posedge clka)  // Flop before data_smpa changes
    outside_right <= outside_right_calc;
```

Referring to Table 1, the first calculation “inside left calc” checks if a is different than b, that is, if there is a transition which c could detect if c(redundant) is the same as a, that is, inside the data eye. The second calculation “outside left-calc” is a transition and does not match. The third calculation “inside_right_calc” is the same as the first calculation but on the right side of the data eye. The fourth calculation “outside_right_calc” is the same as the second, but on the left side of the data eye.

As drift time constants can be several micro-seconds, there are several thousand Unit Interval of data that can be used to determine the edge. Therefore, data eye edge detection need not be performed quickly. In an alternate embodiment, performance may be increased by allowing for a longer accumulation of inside/outside calculations in the interpolator controller 306 in order to allow for a full range of inter-symbol interference patterns to occur.

A transition counter may be used in the interpolator controller 306 to ensure that adequate transitions have occurred before moving to the next clock phase. The stepping of the clock phases through the stepping of interpolator control values during the sweep across the data eye may be performed through a variety of algorithms, such as a binary search or a linear search.

After the left and right edges of the data eye for the even data path have been determined from the perspective of interpolator/sampler 302c, the center position may be calculated or may self-adjust as the left and right edge positions are incremented and decremented. Interpolator 312c may now be placed at its optimum position, allowed to settle, and interpolator/sampler pair 302c swapped for interpolator/sampler pair 302a through the even data path multiplexer 308 by modifying the odd data path select from the interpolator controller 306.

After the interpolator/sampler pair swap is complete, interpolator/sampler pair 302a is redundant and can be used to tune to the center of the data eye for the odd data path in an analogous manner. When the tuning process is complete for the odd data path, interpolator/sampler pair 302a may be swapped for interpolator/sampler pair 302b in the odd data path and interpolator/sampler pair 302b may be used to tune to the center of the data eye for the even data path. In this manner, continuous tuning is provided through the use of a redundant interpolator/sampler pair without interrupting the data stream. The redundant sampler/interpolator pair allows continuous compensation of the offset and cancellation of any potential drift. Offset compensation may be performed each time an interpolator/sampler pair is removed from normal operation, that is, becomes the redundant interpolator/sampler pair.

In an embodiment, the equalizer may be continuously optimized through the use of a redundant equalizer. As shown in FIG. 3, there are two receiver equalizers 316a, 316b. The equalizer setting is continuously optimized to maximize the accuracy of the sampler 314a, 314b, 314c. One of the equalizers 316a, 316b is not used and the settings of the unused equalizer are optimized in situ. The equalizer may be optimized for either maximum eye width or maximum eye height. The equalizer optimization may be performed through the sampler and interpolator pair being calibrated, after performing offset compensation and interpolator tuning through the initial calibration that has already been discussed and by continuous tuning through the redundant sampler/interpolator pair.

If adjusting for maximum width of the data eye, the tuning mechanism described earlier may be used by adjusting the sampling clock phase to move the sampling clock to one edge of the data eye. As long as there is enough margin in the system and fine enough granularity in the equalizer settings, the equalizer parameters may be moved away from their set points to determine if any such variations widen the eye. If a setting in the “unused” equalizer, for example, an RxEq control value sent from the equalization controller that achieves a wider eye is found, it may be locked in (selected) as the equalizer setting.

If adjusting for maximum eye height, an offset is applied to the sampler/equalizer through the sampler or equalizer offset compensation mechanism that may be included in the sampler or the equalizer so that the sampler/equalizer is sensing barely within the vertical eye opening. Then, the equalizer parameters are altered through the RxEq control to the unused equalizer and the offset settings are adjusted up and down to determine if the eye height is larger or smaller. If equalizer parameters that achieve a greater eye height are found, they are locked in. In another embodiment the offset of the spare equalizer and/or sampler is incorporated into the tuning algorithm in order to measure and then optimize for eye height.

In another embodiment, both equalizers 316a, 316b are used if the receiver eye margin is so small or the equalizer parameter granularity is so large that adjusting the equalizer parameters in situ would corrupt the data eye. The redundant equalizer may be trained while the first equalizer is in operation in a similar manner by which the redundant interpolator/sampler pair is equalized. The output of the equalizer may be coupled to the sampler in the redundant interpolator/sampler pair either before or after the interpolator in the redundant interpolator/sampler pair has completed training. Optimization may be for timing or voltage margin. If optimization for voltage margin is desired, the sampler offset mechanism may be used to determine the equalization settings that achieve the greatest data eye height. If optimization for timing margin is desired, the interpolator controller may be used to determine the equalization settings that achieve the greatest data eye width. After equalization optimization is performed in the redundant equalizer, the output of the redundant equalizer may be selected through multiplexer 318 and the other equalizer may begin re-optimization as the redundant equalizer.

An embodiment of the present invention may be used in high speed chip-to-chip links and mixed-signal integrated circuits to perform high-accuracy clock alignment functions.

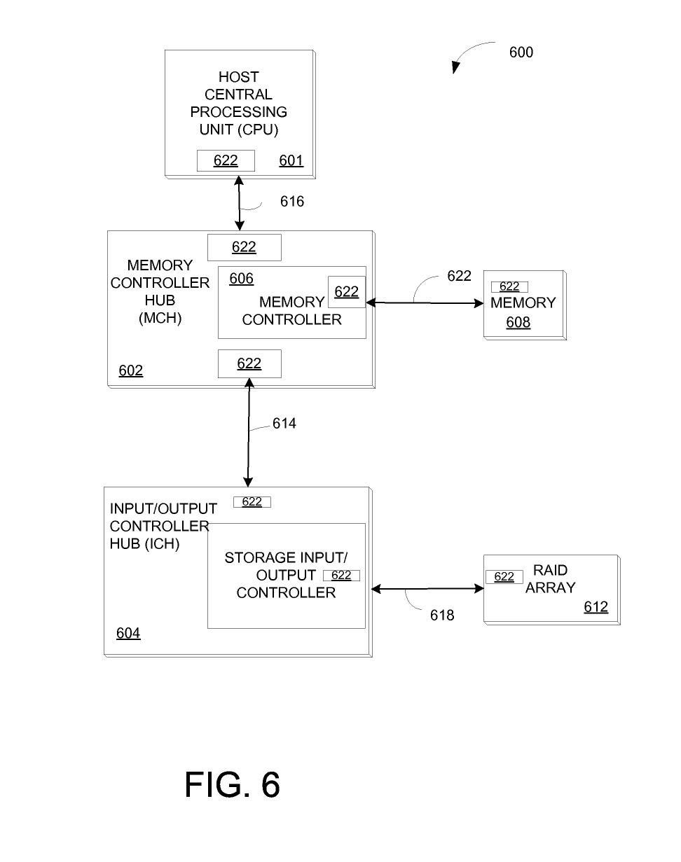

FIG. 6 is a block diagram of a system that includes an embodiment of a receiver that performs continuous retraining according to the principles of the present invention.

The system 600 includes a processor 601, a Memory Controller Hub (MCH) 602 and an Input/Output (I/O) Controller Hub (ICH) 604. The MCH 602 includes a memory controller 606 that controls communication between the processor 601 and memory 608. The processor 601 and MCH 602 communicate over a system bus 616.

The processor 601 may be any one of a plurality of processors such as a single core Intel® Pentium IV® processor, a single core Intel Celeron processor, an Intel® XScale processor or a multi-core processor such as Intel® Pentium D, Intel™ Xeon® processor, or Intel® Core® Duo processor or any other type of processor.

The memory 608 may be Dynamic Random Access Memory (DRAM), Static Random Access Memory (SRAM), Synchronized Dynamic Random Access Memory (SDRAM), Double Data Rate (DDR) RAM, Single Data Rate (SDR) RAM, Double Data Rate 2 (DDR2) RAM, Rambus Dynamic Random Access Memory (RDRAM), Quad Data Rate (QDR) synchronous DRAM or any other type of memory.

The ICH 604 may be coupled to the MCH 602 using a high speed chip-to-chip interconnect 614 such as Direct Media Interface (DMI). DMI supports 2 Gigabit/second concurrent transfer rates via two unidirectional lanes.

The ICH 604 may include a storage I/O controller for controlling communication with at least one storage device 612 coupled to the ICH 604. The storage device may be, for example, a disk drive, Digital Video Disk (DVD) drive, Compact Disk (CD) drive, Redundant Array of Independent Disks (RAID), tape drive or other storage device. The ICH 604 may communicate with the storage device 612 over a storage protocol interconnect 618 using a serial storage protocol such as, Serial Attached Small Computer System Interface (SAS) or Serial Advanced Technology Attachment (SATA).

There may be a receiver 622 at each end of I/O links 616, 614, 618 and 620. For example, there may be a receiver 622 in the memory controller and another receiver 622 in the memory for handling DDR data.

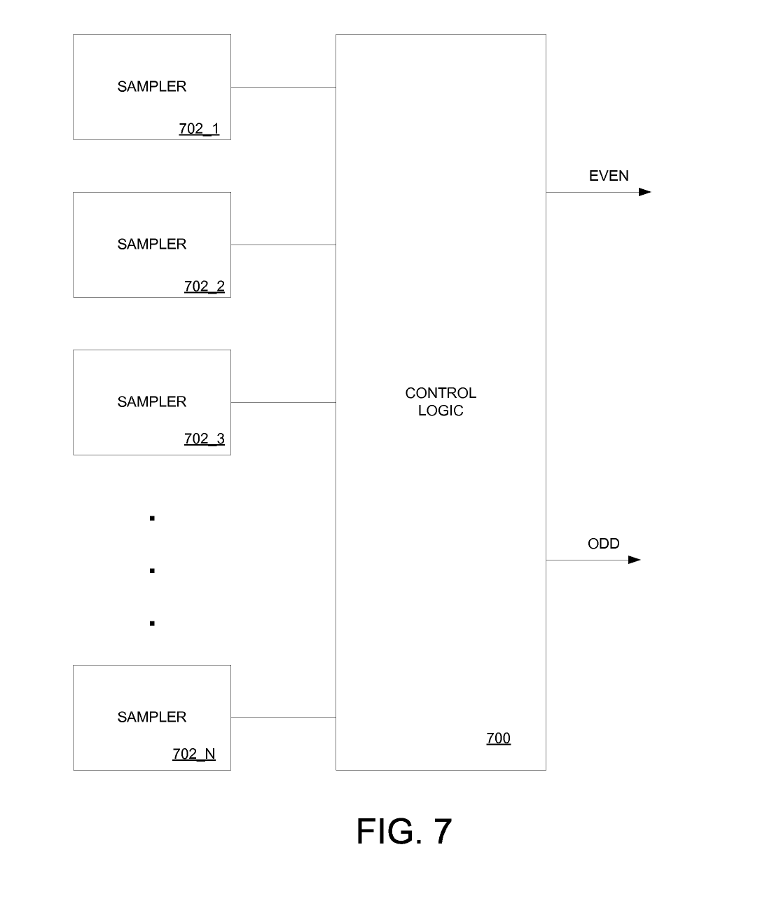

An embodiment of a receiver having three sampler/interpolator pairs has been discussed in conjunction in FIG. 1. However, the invention is not limited to three sampler/interpolator pairs, any number of sampler/interpolator pairs may be used. FIG. 7 is a block diagram of an embodiment of a receiver that includes N interpolator/sampler pairs 702_1 . . . 702_N. Increasing the number of sampler/interpolator pairs 702_1, 702_N results in finer granularity and more accurate determination of the center of the data eye. In one embodiment for a quad data rate transfer, that is, transfer of four data symbols (words) per clock cycle, there may be five through eight sampler/interpolator pairs, that is, N may be five or eight. In an embodiment with five sampler/interpolator pairs, four of the sampler/interpolator pairs are assigned by control logic 700 as primary at any one time, with the fifth sampler/interpolator performing a continuous scan of the receiver data eye for one of the four symbols. The control logic 700 may also perform equalization and jitter tracking. In an embodiment with eight sampler/interpolator pairs, at any time, there are four primary sampler/interpolator pairs and four redundant sampler/interpolator pairs, that is, one for each of the four primary sampler/interpolator pairs.

In another embodiment all the samplers are “primary” and the jitter tracking, equalization and offset functions are moved as a post-processing step into the interpolator controller 306. It will be apparent to those of ordinary skill in the art that a mix of explicit versus logic post-processing may be employed. For example, the offset may be explicitly built into the samplers 314a, 314b, 314c with the jitter tracking function built into the interpolator controller 306.

It will be apparent to those of ordinary skill in the art that methods involved in embodiments of the present invention may be embodied in a computer program product that includes a computer usable medium. For example, such a computer usable medium may consist of a read only memory device, such as a Compact Disk Read Only Memory (CD ROM) disk or conventional ROM devices, or a computer diskette, having a computer readable program code stored thereon.

While embodiments of the invention have been particularly shown and described with references to embodiments thereof, it will be understood by those skilled in the art that various changes in form and details may be made therein without departing from the scope of embodiments of the invention encompassed by the appended claims.

1. An apparatus comprising:
a primary interpolator/sampler to perform sampling of a received data stream;
a redundant interpolator/sampler to perform an eye sweep tuning operation on the received data stream while the primary interpolator/sampler is performing the sampling of the received data stream; and
an interpolator controller to compute an optimum sampling point in the received data stream based on edges of the data eye detected during the eye sweep tuning operation, the interpolator controller to switch operation of the redundant interpolator/sampler to perform sampling of the received data stream using the optimum sampling point and to switch operation of the primary interpolator/sampler to perform the eye sweep tuning operation on the received data stream.

2. The apparatus of claim 1, wherein the received data stream has two data symbols per clock cycle and the primary interpolator/sampler comprises:
a first interpolator/sampler pair to perform sampling of even data in the received data stream; and
a second interpolator/sampler pair to perform sampling of odd data in the received data stream and the redundant interpolator/sampler to alternate performing an eye sweep tuning operation for the even data and the odd data in the received data stream.

3. The apparatus of claim 1, wherein the redundant sampler/interpolator monitors the received data stream by performing a continuous scan of a data eye in the received data stream.

4. The apparatus of claim 1, further comprising:
an equalizer; and
an equalization controller to dynamically optimize a frequency gain parameter while the primary interpolator/sampler is performing the sampling of the received data stream.

5. The apparatus of claim 4, wherein the equalizer includes
a primary equalizer; and
a redundant equalizer, the redundant equalizer to perform continuous tuning to optimize eye width or eye height.

6. The apparatus of claim 1, wherein the received data stream has four data symbols per clock cycle, the primary sampler/interpolator comprises four interpolator/sampler pairs and the redundant sampler/interpolator comprises four interpolator/sampler pairs.

7. The apparatus of claim 1, wherein the received data stream has N data symbols per clock cycle and the redundant sampler/interpolator comprises 1 to N interpolator/sampler pairs.

8. The apparatus of claim 1, wherein an offset is applied to the redundant interpolator/sampler pair to measure the eye height to compute the optimum sampling point.

9. The apparatus of claim 1, wherein an offset is applied to the redundant interpolator/sampler pair to measure eye width or eye height to compute the optimum sampling point.

10. The apparatus of claim 1, wherein the redundant interpolator/sampler continuously monitors changes in eye height or eye width by applying a plurality of offsets using thermally encoded or grey encoded controls with fine granularity to compute the optimum sampling point.

11. A method comprising:
performing, by a primary interpolator/sampler, sampling of a received data stream;
performing an eye sweep tuning operation, by a redundant interpolator/sampler, on the received data stream while the primary interpolator/sampler is performing the sampling of the received data stream; and
computing an optimum sampling point in the received data stream based on edges of the data eye detected during the eye sweep tuning operation;
switching operation of the redundant interpolator/sampler to perform sampling of the received data stream using the optimum sampling point; and
switching operation of the primary interpolator/sampler to perform the eye sweep tuning operation on the received data stream.

12. The method of claim 11, wherein the received data stream has two data symbols per clock cycle and the primary interpolator/sampler comprises:
a first interpolator/sampler pair to perform sampling of even data in the received data stream; and
a second interpolator/sampler pair to perform sampling of odd data in the received data stream and the redundant interpolator/sampler to alternate performing an eye sweep tuning operation for the even data and the odd data in the received data stream.

13. The method of claim 11, wherein the redundant sampler/interpolator monitors the received data stream by performing a continuous scan of a data eye in the received data stream.

14. The method of claim 11, further comprising:
an equalizer; and
an equalization controller to dynamically optimize a frequency gain parameter while the primary interpolator/sampler is performing the sampling of the received data stream.

15. The method of claim 14, wherein the equalizer includes
a primary equalizer; and
a redundant equalizer, the redundant equalizer to perform continuous tuning to optimize eye width or eye height.

16. The method of claim 11, wherein the received data stream has four data symbols per clock cycle, the primary sampler/interpolator comprises four interpolator/sampler pairs and the redundant sampler/interpolator comprises four interpolator/sampler pairs.

17. The method of claim 1, wherein the received data stream has N data symbols per clock cycle and the redundant sampler/interpolator comprises 1 to N interpolator/sampler pairs.

18. A system comprising:
a dynamic random access memory; and
a processor coupled to said memory, the processor comprising a receiver to receive data from the memory, the receiver comprising:
a primary interpolator/sampler to perform sampling of a received data stream;
a redundant interpolator/sampler to perform an eye sweep tuning operation on the received data stream while the primary interpolator/sampler is performing the sampling of the received data stream; and
an interpolator controller to compute an optimum sampling point in the received data stream based on edges of the data eye detected during
the eye sweep tuning operation, the interpolator controller to switch operation of the redundant interpolator/sampler to perform sampling of the received data stream using the optimum sampling point and to switch operation of the primary interpolator/sampler to perform the eye sweep tuning operation on the received data stream.

19. The system of claim 17, wherein the dynamic random access memory is double data rate dynamic random access memory.

20. The system of claim 17, wherein the dynamic random access memory is quad data rate dynamic random access memory.
